(19) United States
(12) Patent Application Publication
(10) Pub. No.: US 2025/0253920 A1
(43) Pub. Date: Aug. 7, 2025

(54) METHODS AND APPARATUSES FOR SIDELINK BEAM MANAGEMENT

(71) Applicant: LENOVO (BEIJING) LIMITED, Beijing (CN)

(72) Inventors: Xin GUO, Beijing (CN); Haipeng LEI, Beijing (CN); Zhennian SUN, Beijing (CN); Xiaodong YU, Beijing (CN)

(21) Appl. No.: 18/856,732

(22) PCT Filed: Apr. 15, 2022
(86) PCT No.: PCT/CN2022/087235

§ 371 Date: Oct. 14, 2024

(51) Int. Cl. H04B 7/06; H04W 72/21

(52) U.S. Cl. CPC H04B 7/06954; H04B 7/0626; H04W 72/21

(57) ABSTRACT

Embodiments of the present disclosure relate to methods and apparatuses for sidelink beam management. According to an embodiment of the present disclosure, a user equipment (UE) can include: a transmitter configured to: transmit a sidelink beam pairing request (sl-BP-RQ) message, wherein the sl-BP-RQ message comprises a sidelink beam pairing (sl-BP) configuration; and transmit sidelink beam pairing reference signal(s) (sl-BP-RS(s)) based on the sl-BP configuration; and a receiver configured to receive sidelink beam pairing feedback(s) (sl-BP-FB(s)) for one or more sl-BP-RSs within the sl-BP-RS(s) based on the sl-BP configuration; and a processor coupled to the transmitter and the receiver.

### TECHNICAL FIELD

Embodiments of the present application are related to wireless communication technology, and more particularly, related to methods and apparatuses for sidelink (SL) beam management.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability and to reduce latency and power consumption. With the development of 3GPP 5G networks, various aspects need to be studied and developed to perfect the 5G technology. Currently, details regarding beam management on SL need to be further discussed.

### SUMMARY OF THE APPLICATION

Embodiments of the present application at least provide a technical solution for SL beam management.

According to some embodiments of the present application, a UE may include a transmitter configured to: transmit a sidelink beam pairing request (sl-BP-RQ) message, wherein the sl-BP-RQ message includes a sidelink beam pairing (sl-BP) configuration; and transmit sidelink beam pairing reference signal(s) (sl-BP-RS(s)) based on the sl-BP configuration; and a receiver configured to receive sidelink beam pairing feedback(s) (sl-BP-FB(s)) for one or more sl-BP-RSs within the sl-BP-RS(s) based on the sl-BP configuration; and a processor coupled to the transmitter and the receiver.

In some embodiments of the present application, the transmitter is further configured to transmit a sidelink beam pairing scheduling request (sl-BP-SR) in a physical uplink control channel (PUCCH) to a BS, wherein the sl-BP-SR includes at least one of: information for triggering an sl-BP procedure; or information for requiring physical uplink shared channel (PUSCH) resources for transmitting the sl-BP-RQ message.

In some embodiments of the present application, the sl-BP-SR is transmitted on a PUCCH resource dedicated for sl-BP.

In some embodiments of the present application, the transmitter is further configured to transmit information for triggering an sl-BP procedure in sidelink control information (SCI) associated with a transport block (TB) carrying the sl-BP-RQ message.

In some embodiments of the present application, the sl-BP configuration includes at least one of the following: type information indicating whether the UE is a UE for transmitting sl-BP-RS or a UE for transmitting sl-BP-FB; an identification (ID) of the UE; a parameter used for scrambling the sl-BP-RS(s); a priority of an intended traffic from the UE; type information of the intended traffic from the UE; a target UE list including at least one intended UE of the sl-BP-RQ message; or a zone ID.

In some embodiments of the present application, the sl-BP configuration includes type information indicating whether the sl-BP-RS(s) is(are) carried by sidelink beam pairing block(s) (S-BPB(s)) or sidelink channel state information reference signal(s) (CSI-RS(s)).

In some embodiments of the present application, the type information indicates that the sl-BP-RS(s) is(are) carried by S-BPB(s), and the sl-BP configuration further includes at least one of the following: a number of S-BPB periods; an offset of a first S-BPB period relative to a reference point, wherein the reference point is a first slot of a first radio frame (RF) or a first slot of a first system frame; a length of each S-BPB period; an S-BPB offset within each S-BPB period; an S-BPB interval within each S-BPB period; a number of S-BPB occasions within each S-BPB period; or an association pattern between occasion(s) for sl-BP-RS and occasion(s) for sl-BP-FB.

In some embodiments of the present application, in order to transmit the sl-BP-RS(s), the transmitter is configured to transmit the sl-BP-RS(s) on occasion(s) for sl-BP-RS in each S-BPB period with beam(s) based on the sl-BP configuration; and in order to receive the sl-BP-FB(s), the receiver is configured to receive the sl-BP-FB(s) on occasion(s) for sl-BP-FB associated with one or more occasions for the one or more sl-BP-RSs, wherein each sl-BP-FB includes an sl-BP-RS occasion indicator indicating an occasion for an sl-BP-RS of the one or more sl-BP-RSs.

In some embodiments of the present application, the type information indicates that the sl-BP-RS(s) is(are) carried by sidelink CSI-RS(s), and the sl-BP configuration further includes at least one of the following: a number of CSI-RS windows; a length of each CSI-RS window; an offset of a first CSI-RS window relative to a reference point, wherein the reference point is one of: a first slot of a first RF; a first slot of a first system frame; a slot of a PUSCH transmission carrying the sl-BP-RQ message; a slot of a physical downlink shared channel (PDSCH) transmission carrying the sl-BP-RQ message from a BS to an intended UE; or a slot in which the UE receives an acknowledgement (ACK) for a successful transmission of the sl-BP-RQ message from a BS to an intended UE; or an association pattern between physical sidelink feedback channel (PSFCH) occasion(s) and slot(s) of sidelink CSI-RS(s).

In some embodiments of the present application, in order to transmit the sl-BP-RS(s), the transmitter is configured to transmit a set of sidelink CSI-RSs as the sl-BP-RS(s) within the number of CSI-RS windows with beam(s) based on the sl-BP configuration, wherein at most one sidelink CSI-RS is transmitted within each CSI-RS window; and in order to receive the sl-BP-FB(s), the receiver is configured to receive each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating that the corresponding sidelink CSI-RS is selected; or a slot indicator indicating the slot of the corresponding sidelink CSI-RS.

In some embodiments of the present application, the type information indicates that the sl-BP-RS(s) is(are) carried by sidelink CSI-RS(s), and the sl-BP configuration further includes at least one of the following: a length of a CSI-RS window; an offset of the CSI-RS window relative to a reference point, wherein the reference point is one of: a first slot of a first RF; a first slot of a first system frame; a slot of a PUSCH transmission carrying the sl-BP-RQ message; a slot of a PDSCH transmission carrying the sl-BP-RQ message from a BS to an intended UE; or a slot in which the UE receives an ACK for a successful transmission of the sl-BP-RQ message from a BS to an intended UE; a maximum number of sidelink CSI-RSs in the CSI-RS window; or an association pattern between PSFCH occasion(s) and slot(s) of sidelink CSI-RS(s).

In some embodiments of the present application, in order to transmit the sl-BP-RS(s), the transmitter is configured to transmit a first number of sidelink CSI-RSs as the sl-BP-RS(s) within the CSI-RS window with beam(s) based on the sl-BP configuration, wherein the first number is less than or equal to the maximum number; and in order to receive the sl-BP-FB(s), the receiver is configured to receive each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating that the corresponding sidelink CSI-RS is selected; or a slot indicator indicating the slot of the corresponding sidelink CSI-RS. In an embodiment, each sidelink CSI-RS of the first number of sidelink CSI-RSs includes an index of the sidelink CSI-RS.

According to some other embodiments of the present application, a UE may include: a receiver configured to: receive an sl-BP-RQ message, wherein the sl-BP-RQ message includes an sl-BP configuration; and receive sl-BP-RS(s) based on the sl-BP configuration; and a processor coupled to the receiver and configured to select one or more sl-BP-RSs within the sl-BP-RS(s); and a transmitter coupled to the processor and configured to transmit sl-BP-FB(s) for the one or more sl-BP-RSs based on the sl-BP configuration.

In some embodiments of the present application, the receiver is further configured to receive information for triggering an sl-BP procedure in downlink control information (DCI) scheduling a PDSCH transmission carrying the sl-BP-RQ message.

In some embodiments of the present application, the receiver is further configured to receive information for triggering an sl-BP procedure in SCI associated with a TB carrying the sl-BP-RQ message.

In some embodiments of the present application, the sl-BP configuration includes at least one of the following: type information indicating whether a UE transmitting the sl-BP-RQ message is a UE for transmitting sl-BP-RS or a UE for transmitting sl-BP-FB; an ID of the UE transmitting the sl-BP-RQ message; a parameter used for scrambling the sl-BP-RS(s); a priority of an intended traffic from the UE transmitting the sl-BP-RQ message; type information of the intended traffic from the UE transmitting the sl-BP-RQ message; a target UE list including at least one intended UE of the sl-BP-RQ message; or a zone ID.

In some embodiments of the present application, the sl-BP configuration includes type information indicating whether the sl-BP-RS(s) is(are) carried by S-BPB(s) or sidelink CSI-RS(s).

In some embodiments of the present application, the type information indicates that the sl-BP-RS(s) is(are) carried by S-BPB(s), and the sl-BP configuration further includes at least one of the following: a number of S-BPB periods; an offset of a first S-BPB period relative to a reference point, wherein the reference point is a first slot of a first RF or a first slot of a first system frame; a length of each S-BPB period; an S-BPB offset within each S-BPB period; an S-BPB interval within each S-BPB period; a number of S-BPB occasions within each S-BPB period; or an association pattern between occasion(s) for sl-BP-RS and occasion(s) for sl-BP-FB.

In some embodiments of the present application, in order to receive the sl-BP-RS(s), the receiver is configured to receive the sl-BP-RS(s) on occasions(s) for sl-BP-RS in each S-BPB period with beam(s) based on the sl-BP configuration; and in order to transmit the sl-BP-FB(s), the transmitter is configured to transmit the sl-BP-FB(s) on occasion(s) for sl-BP-FB associated with one or more occasions for the one or more sl-BP-RSs, wherein each sl-BP-FB includes an sl-BP-RS occasion indicator indicating an occasion for an sl-BP-RS of the one or more sl-BP-RSs.

In some embodiments of the present application, the type information indicates that the sl-BP-RS(s) is(are) carried by sidelink CSI-RS(s), and the sl-BP configuration further includes at least one of the following: a number of CSI-RS windows; a length of each CSI-RS window; an offset of a first CSI-RS window relative to a reference point, wherein the reference point is one of: a first slot of a first RF; a first slot of a first system frame; a slot of a PUSCH transmission carrying the sl-BP-RQ message from another UE to a BS; a slot of a PDSCH transmission carrying the sl-BP-RQ message; or a slot in which the another UE receives an ACK for a successful transmission of the sl-BP-RQ message from the BS to the UE; or an association pattern between PSFCH occasion(s) and slot(s) of sidelink CSI-RS(s).

In some embodiments of the present application, in order to receive the sl-BP-RS(s), the receiver is configured to receive a set of sidelink CSI-RSs as the sl-BP-RS(s) within the number of CSI-RS windows with beam(s) based on the sl-BP configuration, wherein at most one sidelink CSI-RS is received within each CSI-RS window; and in order to transmit the sl-BP-FB(s), the transmitter is configured to transmit each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating the corresponding sidelink CSI-RS is selected; or a slot indicator indicating the slot of the corresponding sidelink CSI-RS.

In some embodiments of the present application, the type information indicates that the sl-BP-RS(s) is(are) carried by sidelink CSI-RS(s), and the sl-BP configuration further includes at least one of the following: a length of a CSI-RS window; an offset of the CSI-RS window relative to a reference point, wherein the reference point is one of: a first slot of a first RF; a first slot of a first system frame; a slot of a PUSCH transmission carrying the sl-BP-RQ message from another UE to a BS; a slot of a PDSCH transmission carrying the sl-BP-RQ message; or a slot in which the another UE receives an ACK for a successful transmission of the sl-BP-RQ message from the BS to the UE; a maximum number of sidelink CSI-RSs in the CSI-RS window; or an association pattern between PSFCH occasion(s) and slot(s) of sidelink CSI-RS.

In some embodiments of the present application, in order to receive the sl-BP-RS(s), the receiver is configured to receive a first number of sidelink CSI-RSs as the sl-BP-RS(s) within the CSI-RS window with beam(s) based on the sl-BP configuration, wherein the first number is less than or equal to the maximum number; and in order to transmit the sl-BP-FB(s), the transmitter is configured to transmit each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating that the corresponding sidelink CSI-RS is selected; or a slot indicator indicating the slot of the corresponding sidelink CSI-RS. In an embodiment, each sidelink CSI-RS of the first number of sidelink CSI-RSs includes an index of the sidelink CSI-RS.

According to some other embodiments of the present application, a BS may include: a receiver configured to: receive an sl-BP-RQ message from a UE, wherein the sl-BP-RQ message includes an sl-BP configuration which indicates at least one intended UE of the sl-BP-RQ message; a transmitter configured to: transmit the sl-BP-RQ message to each of the at least one intended UE; and a processor coupled to the transmitter and the receiver.

In some embodiments of the present application, the receiver is further configured to receive an sl-BP-SR in a PUCCH from the UE, wherein the sl-BP-SR includes at least one of: information for triggering an sl-BP procedure; or information for requiring PUSCH resources for transmitting the sl-BP-RQ message.

In some embodiments of the present application, the sl-BP-SR is received in a PUCCH resource dedicated for sl-BP.

In some embodiments of the present application, the transmitter is further configured to transmit, to each of the at least one intended UE, information for triggering an sl-BP procedure in DCI scheduling a PDSCH transmission carrying the sl-BP-RQ message.

In some embodiments of the present application, the sl-BP configuration includes at least one of the following: type information indicating whether the UE is a UE for transmitting sl-BP-RS or a UE for transmitting sl-BP-FB; an ID of the UE; a parameter used for scrambling sl-BP-RS; a priority of an intended traffic from the UE; type information of the intended traffic from the UE; a target UE list including the at least one intended UE of the sl-BP-RQ message; or a zone ID.

In some embodiments of the present application, the sl-BP configuration includes type information indicating whether the sl-BP-RS is carried by S-BPB or sidelink CSI-RS.

In some embodiments of the present application, the type information indicates that the sl-BP-RS is carried by S-BPB, and the sl-BP configuration further includes at least one of the following: a number of S-BPB periods; an offset of a first S-BPB period relative to a reference point, wherein the reference point is a first slot of a first RF or a first slot of a first system frame; a length of each S-BPB period; a S-BPB offset within each S-BPB period; a S-BPB interval within each S-BPB period; a number of S-BPB occasions within each S-BPB period; or an association pattern between occasion(s) for sl-BP-RS and occasion(s) for sl-BP-FB.

In some embodiments of the present application, the type information indicates that the sl-BP-RS is carried by sidelink CSI-RS, and the sl-BP configuration further includes at least one of the following: a number of CSI-RS windows; a length of each CSI-RS window; an offset of a first CSI-RS window relative to a reference point, wherein the reference point is one of: a first slot of a first RF; a first slot of a first system frame; a slot of a PUSCH transmission carrying the sl-BP-RQ message; a slot of a PDSCH transmission carrying the sl-BP-RQ message; or a slot in which the UE receives an ACK for a successful transmission of the sl-BP-RQ message from the BS to an intended UE; or an association pattern between PSFCH occasion(s) and slot(s) of sidelink CSI-RS(s).

In some embodiments of the present application, the type information indicates that the sl-BP-RS is carried by sidelink CSI-RS, and the sl-BP configuration further includes at least one of the following: a length of CSI-RS window; an offset of the CSI-RS window relative to a reference point, wherein the reference point is one of: a first slot of a first RF; a first slot of a first system frame; a slot of a PUSCH transmission carrying the sl-BP-RQ message; a slot of a PDSCH transmission carrying the sl-BP-RQ message; or a slot in which the UE receives an ACK for a successful transmission of the sl-BP-RQ message from the BS to an intended UE; a maximum number of sidelink CSI-RSs in the CSI-RS window; or an association pattern between PSFCH occasion(s) and slot(s) of sidelink CSI-RS(s).

According to some embodiments of the present application, a method performed by a UE may include: transmitting an sl-BP-RQ message, wherein the sl-BP-RQ message includes an sl-BP configuration; transmitting sl-BP-RS(s) based on the sl-BP configuration; and receiving sl-BP-FB(s) for one or more sl-BP-RSs within the sl-BP-RS(s) based on the sl-BP configuration.

In some embodiments of the present application, the method may further include transmitting an sl-BP-SR in a PUCCH to a BS, wherein the sl-BP-SR includes at least one of: information for triggering an sl-BP procedure; or information for requiring PUSCH resources for transmitting the sl-BP-RQ message. In an embodiment, the sl-BP-SR is transmitted on a PUCCH resource dedicated for sl-BP.

In some embodiments of the present application, the method may further include transmitting information for triggering an sl-BP procedure in SCI associated with a TB carrying the sl-BP-RQ message.

In some embodiments of the present application, transmitting the sl-BP-RS(s) includes transmitting the sl-BP-RS(s) on occasion(s) for sl-BP-RS in each S-BPB period with beam(s) based on the sl-BP configuration; and receiving the sl-BP-FB(s) includes receiving the sl-BP-FB(s) on occasion(s) for sl-BP-FB associated with one or more occasions for the one or more sl-BP-RSs, wherein each sl-BP-FB includes an sl-BP-RS occasion indicator indicating an occasion for an sl-BP-RS of the one or more sl-BP-RSs.

In some embodiments of the present application, transmitting the sl-BP-RS(s) includes transmitting a set of sidelink CSI-RSs as the sl-BP-RS(s) within a number of CSI-RS windows with beam(s) based on the sl-BP configuration, wherein at most one sidelink CSI-RS is transmitted within each CSI-RS window; and receiving the sl-BP-FB(s) includes receiving each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating that the corresponding sidelink CSI-RS is selected; or a slot indicator indicating the slot of the corresponding sidelink CSI-RS.

In some embodiments of the present application, transmitting the sl-BP-RS(s) includes transmitting a number of sidelink CSI-RSs as the sl-BP-RS(s) within a CSI-RS window with beam(s) based on the sl-BP configuration; and receiving the sl-BP-FB(s) includes receiving each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating that the corresponding sidelink CSI-RS is selected; or a slot indicator indicating the slot of the corresponding sidelink CSI-RS. In an embodiment, each sidelink CSI-RS of the number of sidelink CSI-RSs includes an index of the sidelink CSI-RS.

According to some other embodiments of the present application, a method performed by a UE may include: receiving an sl-BP-RQ message, wherein the sl-BP-RQ message includes an sl-BP configuration; receiving sl-BP-RS(s) based on the sl-BP configuration; selecting one or more sl-BP-RSs within the sl-BP-RS(s); and transmitting sl-BP-FB(s) for the one or more sl-BP-RSs based on the sl-BP configuration.

In some embodiments of the present application, the method may further include receiving information for triggering an sl-BP procedure in DCI scheduling a PDSCH transmission carrying the sl-BP-RQ message.

In some embodiments of the present application, the method may further include receiving information for triggering an sl-BP procedure in SCI associated with a TB carrying the sl-BP-RQ message.

In some embodiments of the present application, receiving the sl-BP-RS(s) includes receiving the sl-BP-RS(s) on occasions(s) for sl-BP-RS in each S-BPB period with beam(s) based on the sl-BP configuration; and transmitting the sl-BP-FB(s) includes transmitting the sl-BP-FB(s) on occasion(s) for sl-BP-FB associated with one or more occasions for the one or more sl-BP-RSs, wherein each sl-BP-FB includes an sl-BP-RS occasion indicator indicating an occasion for an sl-BP-RS of the one or more sl-BP-RSs.

In some embodiments of the present application, receiving the sl-BP-RS(s) includes receiving a set of sidelink CSI-RSs as the sl-BP-RS(s) within a number of CSI-RS windows with beam(s) based on the sl-BP configuration, wherein at most one sidelink CSI-RS is received within each CSI-RS window; and transmitting the sl-BP-FB(s) includes transmitting each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating the corresponding sidelink CSI-RS is selected; or a slot indicator indicating the slot of the corresponding sidelink CSI-RS.

In some embodiments of the present application, receiving the sl-BP-RS(s) includes receiving a number of sidelink CSI-RSs as the sl-BP-RS(s) within a CSI-RS window with beam(s) based on the sl-BP configuration; and transmitting the sl-BP-FB(s) includes transmitting each sl-BP-FB of the sl-BP-FB(s) on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following: an ACK indicating that the corresponding sidelink CSI-RS is selected; or a slot indicator indicating the slot of the corresponding sidelink CSI-RS. In an embodiment, each sidelink CSI-RS of the number of sidelink CSI-RSs includes an index of the sidelink CSI-RS.

According to some other embodiments of the present application, a method performed by a BS may include: receiving an sl-BP-RQ message from a UE, wherein the sl-BP-RQ message includes an sl-BP configuration which indicates at least one intended UE of the sl-BP-RQ message; and transmitting the sl-BP-RQ message to each of the at least one intended UE.

In some embodiments of the present application, the method may further include receiving an sl-BP-SR in a PUCCH from the UE, wherein the sl-BP-SR includes at least one of: information for triggering an sl-BP procedure; or information for requiring PUSCH resources for transmitting the sl-BP-RQ message. In an embodiment, the sl-BP-SR is received in a PUCCH resource dedicated for sl-BP.

In some embodiments of the present application, the method may further include transmitting, to each of the at least one intended UE, information for triggering an sl-BP procedure in DCI scheduling a PDSCH transmission carrying the sl-BP-RQ message.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary beam pairing process for beam-based communication between two sidelink UEs according to some embodiments of the present application;

FIG. 3 illustrates an exemplary assistance information transmission procedure according to some embodiments of the present application;

FIG. 4 illustrates a flowchart of an exemplary beam pairing procedure according to some embodiments of the present application;

FIG. 5 illustrates an exemplary S-BPB slot according to some embodiments of the present application;

FIG. 6 illustrates an exemplary configuration for S-BPB periods for an sl-BP procedure according to some embodiments of the present application;

FIG. 7 illustrates an exemplary distribution of occasions for S-BPB according to some embodiments of the present application;

FIG. 8 illustrates an exemplary association pattern between occasion(s) for sl-BP-RS and occasion(s) for sl-BP-FB according to some embodiments of the present application;

FIG. 9 illustrates another exemplary association pattern between occasion(s) for sl-BP-RS and occasion(s) for sl-BP-FB according to some embodiments of the present application;

FIG. 10 illustrates an exemplary timing diagram for sidelink beam pairing according to some embodiments of the present application;

FIG. 11 illustrates an exemplary configuration for CSI-RS windows for an sl-BP procedure according to some embodiments of the present application;

FIG. 12 illustrates another exemplary timing diagram for sidelink beam pairing according to some embodiments of the present application;

FIG. 13 illustrates an exemplary configuration for a CSI-RS window for an sl-BP procedure according to some embodiments of the present application;

FIG. 14 illustrates another exemplary timing diagram for sidelink beam pairing according to some embodiments of the present application;

FIG. 15 illustrates another exemplary timing diagram for sidelink beam pairing according to some embodiments of the present application;

FIG. 16 illustrates another exemplary assistance information transmission procedure according to some embodiments of the present application; and

FIG. 17 illustrates a simplified block diagram of an exemplary apparatus for beam pairing according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

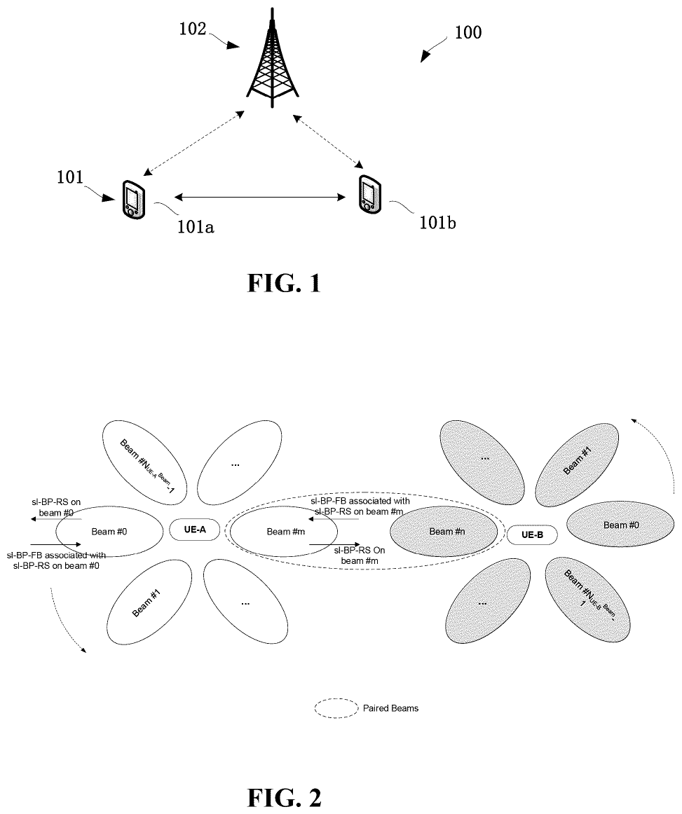

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 101 may include wearable devices, such as smart watches, fitness bands, optical head-mounted displays, or the like.

According to some embodiments of the present application, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high-altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

In a cell search procedure, a UE (e.g., UE 101a or UE 101b) may acquire the time and frequency synchronization to a cell and determine a physical layer ID of the cell by searching for primary synchronization signal (PSS) and secondary synchronization signal (SSS) and decoding physical broadcast channel (PBCH) carried by synchronization signal (SS)/PBCH block (SSB).

The PBCH may carry a master information block (MIB), which is an integrated part of the SSB and is used for signaling the most essential system information related to access to the cell, e.g., the frequency position and timing of the cell. In order to enable the UE to monitor a physical downlink control channel (PDCCH) scheduling a PDSCH carrying system information block 1 (SIB1), MIB provides the needed configuration for monitoring the PDCCH in pdcch-ConfigSIB1 as specified in 3GPP standard documents.

In an initial access procedure in NR Uu beamforming scenario, a BS may transmit one or more SSBs to a UE, and each SSB of the one or more SSBs is transmitted with a different beam. After receiving the one or more SSBs, the UE may select an SSB satisfying a certain condition from the one or more SSBs. Then, the UE may transmit a random access preamble in a random access channel occasion (RO) associated with the selected SSB over a physical random access channel (PRACH), thereby indicating the selected SSB to the BS. Specifically, an RO is a time-frequency resource for transmitting the random access preamble. The information for determining RO(s) and association between SSB(s) and RO(s) are indicated in SIB1.

In sidelink evolution, sidelink beam management may be one objective which needs to be studied. The sidelink beam management may include initial beam pairing, beam maintenance, and beam failure recovery. Specifically, the initial beam pairing may include selecting beam-pair(s) to be used for subsequent communication between two sidelink UEs.

As described above, the initial access procedure in NR Uu beamforming scenario is performed by employing SSB and feedback over PRACH. Although sidelink SSB (S-SSB) is also used for synchronization on sidelink, the aforementioned method employing SSB and feedback may not be applied for the sidelink beam pairing process due to the following reasons: (1) in a synchronization procedure between a UE and a synchronization reference UE (i.e., SyncRef UE) in NR vehicle to everything (V2X), there is no feedback resources for the UE to indicate the selected S-SSB back to the SyncRef UE; and (2) since the sidelink resources are determined based on sensing, transmitting feedback over PRACH may introduce intolerable processing latency for initial beam pairing or beam failure recovery. Given this, the method of transmitting feedback over PRACH is complicated for NR V2X and is not applicable to be used in NR V2X.

In addition, without assistance information, the sidelink beam pairing method needs to rely on transmitting and scanning periodic reference signals. The design of always-on reference signal is inefficient in terms of energy performance. Therefore, how to design a sidelink beam pairing procedure exploiting assistance information so as to enhance energy efficiency needs to be addressed.

Embodiments of the present application provide improved solutions for SL beam management, which propose configurations, signalings, and procedures for sidelink beam pairing based on assistance information. More details will be described in the following text in combination with the appended drawings.

FIG. 2 illustrates an exemplary beam pairing process for beam-based communication between two sidelink UEs according to some embodiments of the present application. In some embodiments of the present application, the beam-based sidelink communication may be performed in frequency range 2 (FR2) as specified in 3GPP standard documents. It is contemplated that the methods described in the embodiments of the present application may also be performed in new frequency ranges which can be extended to or complemented in future 3GPP releases.

Referring to FIG. 2, in a beam-based sidelink unicast transmission scenario, a UE-A and a UE-B may use directional beams when transmitting and receiving over sidelink. For example, the UE-A incudes N_{UE-A}^{Beam} beams (e.g., beam #0, beam #1, . . . , and beam #N_{UE-A}^{Beam}−1), and the UE-B includes N_{UE-B}^{Beam} beams (e.g., beam #0, beam #1, . . . , and beam #N_{UE-B}^{Beam}−1). Given this, before performing sidelink communications therebetween, the UE-A and the UE-B need to identify beam pair(s) (e.g., beam #m of the UE-A and beam #n of the UE-B) through a beam pairing procedure such that the identified beam pair(s) can be used for subsequent beam-based communications. Specifically, during the beam pairing procedure, the beam pair(s) may be identified by transmitting and receiving sl-BP-RS and sl-BP-FB between the UE-A and the UE-B. For example, as shown in FIG. 2, the UE-A may transmit an sl-BP-RS on each of beam #0, beam #1, . . . , and beam #N_{UE-A}^{Beam}−1 of the UE-A to the UE-B. The UE-B may receive the sl-BP-RSs from the UE-A with each of beam #0, beam #1, . . . , and beam #N_{UE-B}^{Beam}−1 of the UE-B, and select sl-BP-RS(s) (e.g., sl-BP-RSs on beam #m of the UE-A) satisfying a certain condition. The beam(s) of the UE-B (e.g., beam #n of the UE-B) on which the selected sl-BP-RS(s) is(are) received will be used for subsequent beam-based communications between the UE-A and the UE-B. The UE-B may transmit sl-BP-FB(s) associated with the selected sl-BP-RS(s) to indicate the selected sl-BP-RS(s) to the UE-A. Then, the UE-A may receive the sl-BP-FB(s) and identify the selected sl-BP-RS(s) based on the received sl-BP-FB(s). The UE-A may also identify the beam(s) of the UE-A (e.g., beam #m of the UE-A) associated with the selected sl-BP-RS(s) (i.e., the beam(s) on which the selected sl-BP-RS(s) is(are) transmitted). The identified beam(s) will be used for subsequent beam-based communications between the UE-A and the UE-B. In this way, the beam pair(s) used for subsequent communications may be identified. In some embodiments of the present application, the sl-BP-FB may also be referred to as sidelink beam pairing report.

According to some embodiments of the present application, the sidelink beam pairing process illustrated in FIG. 2 may be performed based on assistance information and may include two stages, i.e., stage 1 and stage 2. Stage 1 may refer to transmitting and receiving assistance information (e.g., a trigger for sl-BP procedure, sl-BP configuration, etc.). Stage 2 may refer to transmitting and receiving sl-BP-RS and sl-BP-FB in FR2 as specified in 3GPP standard documents. Depending on the different connections involved in transmitting assistance information in stage 1, the sidelink beam pairing procedure may be classified into two cases, i.e., Case #1 and Case #2. For example, Case #1 may refer to that the assisted connection for transmitting assistance information is Un link (i.e., the assistance information is transmitted from a UE to another UE via a BS). Case #2 may refer to that the assisted connection for transmitting assistance information is sidelink (i.e., the assistance information is directly transmitted from a UE to another UE via sidelink).

In stage 2, there may be multiple combinations depending on sl-BP-RS and sl-BP-FB. For example, sl-BP-RS may be carried by S-BPB or SL CSI-RS, while sl-BP-FB may be carried by S-BPB, PSFCH or PSSCH. In response to the sl-BP-RS being SL CSI-RS, the CSI-RS may be transmitted based on method 1 (i.e., the transmissions of CSI-RS are constrained by a number of CSI-RS windows, which will be described in detail below) or method 2 (i.e., the transmissions of CSI-RS are constrained by a number of sidelink CSI-RSs, which will be described in detail below).

The following Table 1 illustrates the possible cases of the sidelink beam pairing procedure. In response to the assisted connection being Uu link, the spectrum range for assisted connection may be either FR1 or FR2 as specified in 3GPP standard documents. In response to the assisted connection being sidelink, the spectrum range for assisted connection may be FR1 as specified in 3GPP standard documents. In stage 2, the spectrum range may be FR2 as specified in 3GPP standard documents.

TABLE 1

| | Stage 1 | | Stage 2 | | |
|---|---|---|---|---|---|
| | Assisted | Spectrum | | | Spectrum |
| | Connection | Range | sl-BP-RS | sl-BP-FB | Range |
| Case#1 | Uu | FR1, FR2 | S-BPB, SL | S-BPB, | FR2 |
| | | | CSI-RS | PSFCH, | |
| | | | | PSSCH | |
| Case#2 | SL | FR1 | S-BPB, SL | S-BPB, | FR2 |
| | | | CSI-RS | PSFCH, | |
| | | | | PSSCH | |

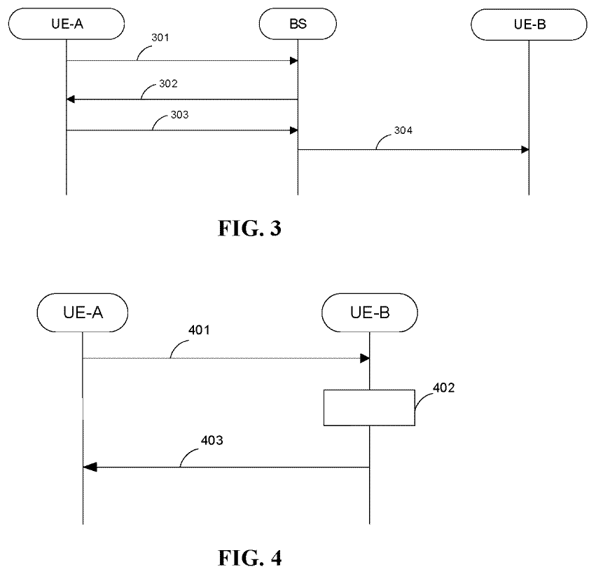

FIG. 3 illustrates an exemplary assistance information transmission procedure (i.e., stage 1) according to some embodiments of the present application. The procedure in FIG. 3 may be applied to the aforementioned Case #1.

Referring to FIG. 3, in step 301, UE-A may transmit an sl-BP-SR in a PUCCH to a serving BS of the UE-A to request resources on PUSCH for transmitting an sl-BP-RQ message. The sl-BP-SR may include at least one of: information (e.g., in form of one-bit) for triggering an sl-BP procedure; or information for requiring PUSCH resources for transmitting the sl-BP-RQ message. For example, the information for requiring PUSCH resources may include: a buffer status report (BSR) of the UE-A, quality of service (QOS) requirements (e.g., latency requirement, priority, etc.) of the message to be transmitted to the BS, and so on.

In some embodiments of the present application, the sl-BP-SR may be transmitted on a PUCCH resource dedicated for sl-BP. The dedicated PUCCH resource may be configured or pre-configured to the UE. Once receiving a scheduling request from the UE-A on this dedicated PUCCH resource (the scheduling request may or may not include information for triggering an sl-BP procedure), the BS may identify that the scheduling request is an sl-BP-SR to request resources on PUSCH for transmitting an sl-BP-RQ message.

Consequently, in step 301, the BS may receive the sl-BP-SR from the UE-A. Then, in step 302, the BS may schedule PUSCH resources for transmitting the sl-BP-RQ message to the UE-A based on the sl-BP-SR. For example, the BS may transmit a response on PDCCH indicating the scheduled PUSCH resources to the UE-A.

After receiving the response from the BS, in step 303, the UE-A may transmit an sl-BP-RQ message on the scheduled PUSCH resources to the BS. For example, the sl-BP-RQ message may be transmitted to the BS via a medium access control (MAC) control element (CE). The sl-BP-RQ message may include an sl-BP configuration.

According to some embodiments of the present application, the sl-BP configuration includes at least one of the following:
Type information indicating the UE-A is a UE for transmitting sl-BP-RS or a UE for transmitting sl-BP-FB. In an embodiment, the type information may include 1 bit. For example, the value “1” of the type information may indicate that the UE-A transmitting the sl-BP-RQ message is a UE for transmitting sl-BP-RS, and the value “0” of the type information may indicate that the UE-A transmitting the sl-BP-RQ message is a UE for transmitting sl-BP-FB, or vice versa.
An ID of the UE-A. In an embodiment, the ID of the UE-A may be allocated by a V2X application layer and can be used for an intended UE (e.g., UE-B) to identify an sl-BP procedure associated with the sl-BP-RQ message.
A parameter used for scrambling sl-BP-RS(s). In some embodiments of the present application, the parameter may include a radio network temporary identifier (RNTI) dedicated for sidelink beam pairing (e.g., SL-BP-RNTI) which can be used for an intended UE (e.g., UE-B) to distinguish the sl-BP-RS(s) from other reference signals. In an embodiment, a set of RNTIs dedicated for sidelink beam pairing may be configured or pre-configured to a UE (e.g., UE-A or UE-B), and the UE-A may select one RNTI from the set of RNTIs to be included in the parameter.
A priority of an intended traffic from the UE-A, which can be used for an intended UE (e.g., UE-B) to identify the sl-BP procedure associated with the sl-BP-RQ message.
Type information of the intended traffic from the UE-A, which can be used for an intended UE (e.g., UE-B) to identify the sl-BP procedure associated with the sl-BP-RQ message.
A target UE list including at least one intended UE of the sl-BP-RQ message (e.g., UE-B), which can be used for the BS (or other UE(s)) to identify target UE(s) of the sl-BP-RQ message.
A zone ID. In an embodiment, the zone ID indicates a location of the UE-A, which can be used for an intended UE (e.g., UE-B) to select beam(s) for receiving sl-BP RS(s) from the UE-A (in the case that the UE-A is a UE for transmitting sl-BP RS) or select beam(s) for transmitting sl-BP RS(s) to the UE-A (in the case that the UE-B is a UE for transmitting sl-BP RS) during the sl-BP procedure in FR2.

In addition to the above configuration information, the sl-BP configuration may also include at least one of type information indicating whether the sl-BP-RS(s) is(are) carried by S-BPB(s) or sidelink CSI-RS(s) or configuration information for sl-BP-RS and sl-BP-FB (which will be described in detail below).

Consequently, in step 303, the BS may receive the sl-BP-RQ message from the UE-A. Then, the BS may decode the sl-BP-RQ message and identify at least one intended UE of the sl-BP-RQ message (e.g., the at least one intended UE included in the target UE list). Then, in step 304, the BS may transmit the sl-BP-RQ message to each of the at least one intended UE (e.g., UE-B). Specifically, the BS may transmit DCI to each of the at least one intended UE. The DCI may include information (e.g., in form of one-bit) for triggering an sl-BP procedure and schedule a PDSCH transmission carrying the sl-BP-RQ message.

In the embodiments illustrated in FIG. 3, the sl-BP-RQ message is transmitted from the UE-A to the UE-B via the BS. In some embodiments, the UE-A is a UE for transmitting sl-BP-RS and the UE-B is a UE for transmitting sl-BP-FB. In some other embodiments, the UE-A is a UE for transmitting sl-BP-FB and the UE-B is a UE for transmitting sl-BP-RS.

As described above, in stage 2 of an assistance information based sidelink beam pairing procedure, two UEs (e.g., UE-A and UE-B) may perform a beam pairing procedure in FR2 based on the assistance information (e.g., sl-BP configuration) transmitted and received in stage 1. FIG. 4 illustrates a flowchart of an exemplary beam pairing procedure according to some embodiments of the present application. In the example of FIG. 4, UE-A may be the UE-A transmitting the sl-BP-RQ message in FIG. 3, and UE-B may be the UE-B receiving the sl-BP-RQ message in FIG. 3. Moreover, the UE-A is a UE for transmitting sl-BP-RS and the UE-B is a UE for transmitting sl-BP-FB. It is contemplated that the UE-A can be a UE for transmitting sl-BP-FB and the UE-B can be a UE for transmitting sl-BP-RS in other embodiments and inverse operations may be apply.

Referring to FIG. 4, in step 401, the UE-A may transmit sl-BP-RS(s) based on the sl-BP configuration. Consequently, in step 401, the UE-B may receive sl-BP-RS(s) based on the sl-BP configuration. Then, in step 402, the UE-B may select one or more sl-BP-RSs within the sl-BP-RS(s). After that, in step 403, the UE-B may transmit sl-BP-FB(s) for the one or more sl-BP-RSs based on the sl-BP configuration to the UE-A. Through the above procedure, the UE-A and the UE-B may identify beam(s) for sidelink communication therebetween.

According to some embodiments of the present application, Case #1 may include a Case #1-1, which refers to a case where both sl-BP-RS and sl-BP-FB are carried by S-BPB. Thus, the type information included in the sl-BP configuration may indicate that the sl-BP-RS(s) is(are) carried by S-BPB(s).

Specifically, an S-BPB may occupy one slot in the time domain and uses the same numerology as the one configured or pre-configured in the SL bandwidth part (BWP), i.e., using the same numerology as the one for physical sidelink control channel (PSCCH) and physical sidelink shared channel (PSSCH). An S-BPB may include a physical sidelink broadcast channel (PSBCH), a primary sequence and a secondary sequence. In some embodiments of the present application, for a normal CP, the PSBCH, the primary sequence, and the secondary sequence are carried in the first 13 symbols of an S-BPB slot (i.e., a slot used to carry an S-BPB). In some embodiments of the present application, for an extended CP, the PSBCH, the primary sequence, and the secondary sequence are carried in the first 11 symbols of an S-BPB slot. The last symbol in an S-BPB slot is used as a guard symbol.

An S-BPB is not frequency multiplexed with any other sidelink physical channel within the SL BWP, i.e., S-BPBs are not transmitted in the slots of a resource pool for sidelink transmission. The frequency location of an S-BPB is configured or pre-configured within the SL BWP. As a result, a UE does not need to perform blind detection in the frequency domain to find an S-BPB. The bandwidth of an S-BPB may also be configured or pre-configured for the UE. For example, the bandwidth of an S-BPB (hereinafter referred to as S-BPB bandwidth) may span 11 common resource blocks (RBs) within the SL BWP. Since an RB consists of 12 subcarriers, the S-BPB bandwidth spans 11×12=132 subcarriers. However, the bandwidth of an S-BPB may be any other values in some other embodiments of the present application.

In some embodiments of the present application, each of the primary sequence and the secondary sequence may include a sequence of 127 bits. The primary sequence and the secondary sequence are modulated with binary phase shift keying (BPSK) such that each sequence occupies 127 subcarriers in a symbol within the S-BPB bandwidth, which are from the third subcarrier relative to the start of the S-BPB bandwidth up to the 129th subcarrier.

In some embodiments of the present application, for a normal CP, the PSBCH may be transmitted on the first symbol and eight symbols after the primary sequence and the secondary sequence in an S-BPB slot. In some embodiments of the present application, for an extended CP, the PSBCH may be transmitted on the first symbol and six symbols after the primary sequence and the secondary sequence in an S-BPB slot. The first symbol (i.e., the first PSBCH symbol) of the S-BPB is used for automatic gain control (AGC).

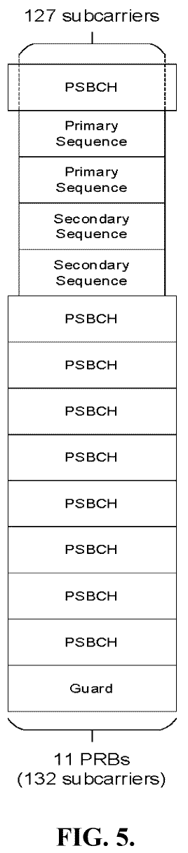

FIG. 5 illustrates an exemplary S-BPB slot according to some embodiments of the present application. In the embodiments of FIG. 5, the normal CP is used.

Referring to FIG. 5, the S-BPB occupies one slot in the time domain and occupies 11 RBs (i.e., 132 subcarriers) in the frequency domain (i.e., the S-BPB bandwidth M_{S-BPB}=11 RBs=132 subcarriers). In the example of FIG. 5, the S-BPB slot may include 14 OFDM symbols in total. The primary sequence is transmitted repeatedly on the second and third symbols in the S-BPB slot. The secondary sequence is transmitted repeatedly on the fourth and fifth symbols in the S-BPB slot. The PSBCH is transmitted on the first symbol and eight symbols after the secondary sequence in the S-BPB slot. The PSBCH in the first symbol of the S-BPB slot is used for AGC. The last symbol in the S-BPB slot is used as a guard symbol.

For Case #1-1, the configuration information for sl-BP-RS and sl-BP-FB included in the sl-BP configuration may further include at least one of the following:
a number of S-BPB periods;
an offset of a first S-BPB period relative to a reference point, wherein the reference point is a first slot (e.g., slot #0) of a first RF (e.g., RF #0) or a first slot (e.g., slot #0) of a first system frame (e.g., system frame number (SFN) #0);
a length of each S-BPB period;
a S-BPB offset within each S-BPB period;
a S-BPB interval within each S-BPB period;
a number of S-BPB occasions within each S-BPB period; or
an association pattern between occasion(s) for sl-BP-RS and occasion(s) for sl-BP-FB.

For example, the sl-BP configuration may include: a parameter Num_{period}, a parameter Offset, and a parameter Period_{S-BPB}. The parameter Num_{period} may indicate a number of S-BPB periods for a beam pairing procedure. The parameter Offset may indicate an offset of a first S-BPB period relative to a reference point, and may be represented in number of frame, slot or millisecond (ms). The parameter Period_{S-BPB} may indicate a length of each S-BPB period, and may be represented in number of ms or frame. Based on the above three parameters, a UE (e.g., UE-A or UE-B) may determine a configuration for S-BPB periods (e.g., distribution of S-BPB periods) for an sl-BP procedure.

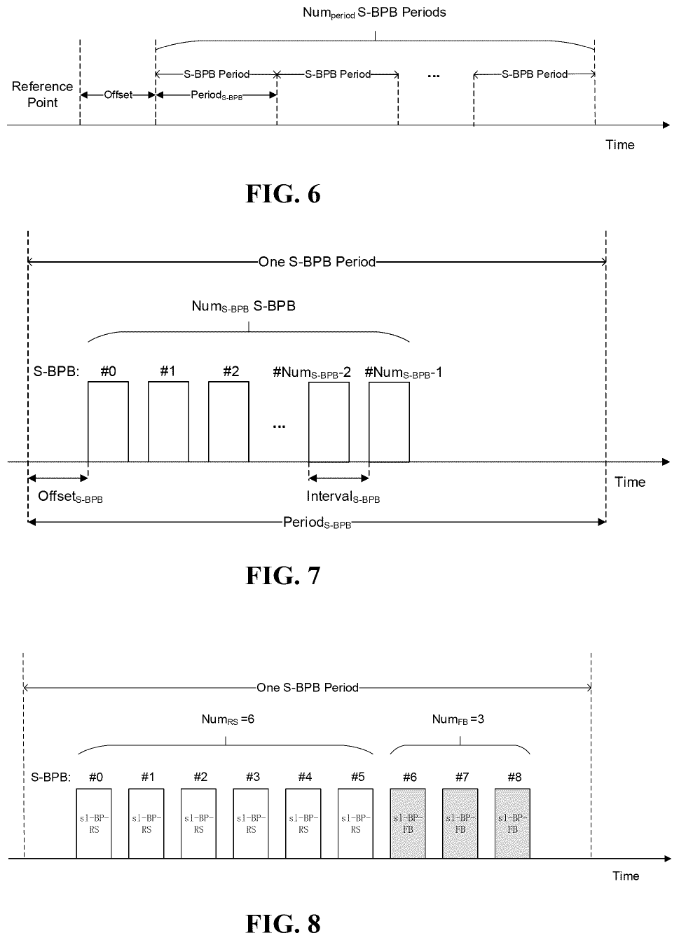

FIG. 6 illustrates an exemplary configuration for S-BPB periods for an sl-BP procedure according to some embodiments of the present application. Specifically, in FIG. 6, the number of S-BPB periods for the sl-BP procedure is Num_{period}. FIG. 6 also shows an offset (e.g., Offset) of a first S-BPB period relative to a reference point and a length of each S-BPB period (e.g., Period_{S-BPB}).

For one S-BPB period, the configuration information for sl-BP-RS and sl-BP-FB may include a configuration for S-BPB, which may include a parameter Offset_{S-BPB}, a parameter Interval_{S-BPB}, and a parameter Num_{S-BPB}.

The parameter Offset_{S-BPB} may indicate an S-BPB offset within each S-BPB period. Specifically, the S-BPB offset may refer to an offset in time of the first S-BPB within an S-BPB period relative to the first slot of the S-BPB period. The parameter Offset_{S-BPB} may be represented in number of frame, slot or ms.

The parameter Interval_{S-BPB} may indicate an S-BPB interval within each S-BPB period. Specifically, the S-BPB interval may refer to an interval between two adjacent occasions for S-BPBs within an S-BPB period. The parameter Interval_{S-BPB} may be represented in number of frame, slot or ms.

The parameter Num_{S-BPB} may indicate a number of S-BPB occasions within each S-BPB period.

Based on the above three parameters, a UE (e.g., UE-A or UE-B) may determine a distribution of occasions for S-BPB.

FIG. 7 illustrates an exemplary distribution of occasions for S-BPB according to some embodiments of the present application. Specifically, in FIG. 7, the number of S-BPB occasions within an S-BPB period is Num_{S-BPB} and the occasion for each S-BPB spans one slot in the time domain. FIG. 7 also shows an S-BPB offset (e.g., Offset_{S-BPB}) and an S-BPB interval (e.g., Interval_{S-BPB}).

According to some embodiments of the present application, the association pattern included in the sl-BP configuration may indicate occasion(s) for sl-BP-FB associated with each occasion for sl-BP-RS in each sidelink beam pairing process.

FIG. 8 illustrates an exemplary association pattern between occasion(s) for sl-BP-RS and occasion(s) for sl-BP-FB according to some embodiments of the present application.

Referring to FIG. 8, it is assumed that: in each S-BPB period, the occasions for transmitting sl-BP-RSs are S-BPB occasions #0, #1, #2, #3, #4, and #5 (i.e., the number of occasions for sl-BP-RS Num_{RS}=6), and the occasions for transmitting sl-BP-FBs are S-BPB occasions #6, #7, and #8 (i.e., the number of occasions for sl-BP-FB Num_{FB}=3). The association pattern may indicate that each of occasions #0, #1, #2, #3, #4, and #5 is associated with occasions #6, #7, and #8.

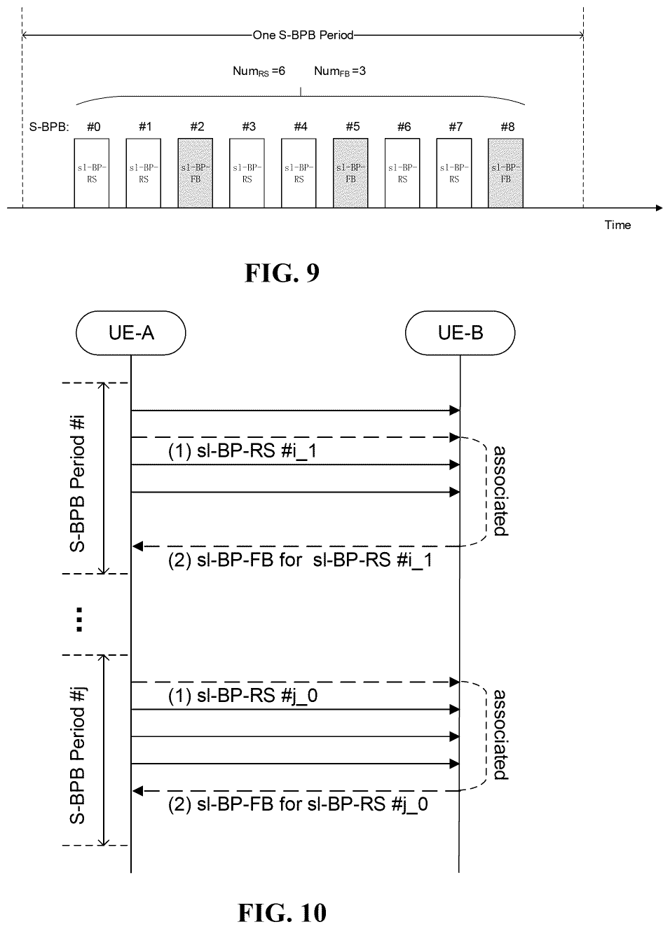

FIG. 9 illustrates another exemplary association pattern between occasion(s) for sl-BP-RS and occasion(s) for sl-BP-FB according to some embodiments of the present application.

Referring to FIG. 9, it is assumed that: in each S-BPB period, the occasions for transmitting sl-BP-RSs are S-BPB occasions #0, #1, #3, #4, #6, and #7 (i.e., the number of occasions Num_{RS}=6), and the occasions for transmitting sl-BP-FBs are S-BPB occasions #2, #5, and #8 (i.e., the number of occasions Num_{FB}=3). The association pattern may indicate that: occasion #2 is associated with occasions #0 and #1, which means that the feedback for sl-BP-RS on each of occasions #0 and #1 will be transmitted on occasion #2; occasion #5 is associated with occasions #3 and #4, which means that the feedback for sl-BP-RS on each of occasions #3 and #4 will be transmitted on occasion #5; and occasion #8 is associated with occasions #6 and #7, which means that the feedback for sl-BP-RS on each of occasions #6 and #7 will be transmitted on occasion #8.

The association patterns shown in FIG. 8 and FIG. 9 are only for illustrative purpose. It is contemplated that other association patterns may apply according to some other embodiments of the present application.

Based on the sl-BP configuration described above with respect to Case #1-1, the UE-A and the UE-B may perform corresponding operations as illustrated in FIG. 4. Specifically, in step 401, the UE-A may transmit the sl-BP-RS(s) on occasions(s) for sl-BP-RS in each S-BPB period with beam(s) based on the sl-BP configuration. For example, on each occasion for sl-BP-RS, the UE-A may transmit an sl-BP-RS with a beam of the UE-A.

Consequently, in step 401, the UE-B may receive the sl-BP-RS(s) on occasions(s) for sl-BP-RS in each S-BPB period with beams of the UE-B based on the sl-BP configuration.

After receiving the sl-BP-RS(s), according to some embodiments of the present application, the UE-B may select one or more sl-BP-RSs within the received sl-BP-RS(s) in step 402. In an embodiment of the present application, the UE-B may determine that beam(s) receiving the one or more sl-BP-RSs are the paired beam(s) for beam pairing with the UE-A.

In some embodiments of the present application, the UE-B may measure a reference signal received power (RSRP) for each received sl-BP-RS and select the one or more sl-BP-RSs based on the measured RSRP for each sl-BP-RS. In an embodiment, the one or more sl-BP-RSs selected by the UE-B may be sl-BP-RSs associated with measured RSRPs larger than or equal to an RSRP threshold. In another embodiment, the one or more sl-BP-RSs selected by the UE-B may be sl-BP-RSs associated with measured RSRPs larger than RSRPs associated with the other sl-BP-RSs.

After that, in step 403, the UE-B may transmit sl-BP-FB(s) on occasion(s) for sl-BP-FB associated with one or more occasions for the one or more sl-BP-RSs. Specifically, the occasion(s) for transmitting the sl-BP-FB(s) may be determined based on the association pattern in the sl-BP configuration. In some embodiments of the present application, each sl-BP-FB may include an sl-BP-RS occasion indicator indicating an occasion for an sl-BP-RS of the one or more sl-BP-RSs. In some other embodiments of the present application, an sl-BP-FB may not include the sl-BP-RS occasion indicator.

According to some other embodiments of the present application, in the case that none of the received sl-BP-RS(s) satisfies a condition (e.g., the measured RSRP is larger than or equal to an RSRP threshold), the UE-B does not transmit any feedback on occasion(s) for sl-BP-FB to the UE-A.

The UE-A may attempt to receive sl-BP-FB(s) on the occasion(s) for sl-BP-FB for receiving sl-BP-FB(s) based on the sl-BP configuration.

In some embodiments of the present application, the UE-A may receive the sl-BP-FB(s) for the one or more sl-BP-RSs within the sl-BP-RS(s) in step 403. Then, the UE-A may identify beam(s) of the UE-A based on the received sl-BP-FB(s). The identified beam(s) may be the paired beam(s) for beam pairing with the UE-B.

In some embodiments, the UE-A may identify beam(s) based on an sl-BP-RS occasion indicator indicating an occasion for an sl-BP-RS in each sl-BP-FB. For example, based on the sl-BP-RS occasion indicator, the UE-A may determine a beam for transmitting sl-BP-RS on the occasion indicated by the sl-BP-RS occasion indicator, and thus the UE-A may determine the beam as a paired beam for beam pairing with the UE-B.

In some other embodiments, the UE-A may identify beams based on the association pattern between occasions for sl-BP-RS(s) and occasions for sl-BP-FB(s). For example, the association pattern may indicate that an occasion for sl-BP-FB is associated with a corresponding occasion for sl-BP-RS. Then, after receiving the sl-BP-FB on the occasion, the UE-A may determine the corresponding occasion for sl-BP-RS, and then determine the beam used on the corresponding occasion for sl-BP-RS to be a paired beam for beam pairing with the UE-B.

FIG. 10 illustrates an exemplary timing diagram for sidelink beam pairing according to some embodiments of the present application.

In FIG. 10, two S-BPB periods #i and #j in a plurality of S-BPB periods for sidelink beam pairing procedure are illustrated.

In each S-BPB period, the occasions for sl-BP-FB may be located fixedly with respect to occasions for sl-BP-RS based on the association pattern. For example, the dashed arrows indicate the occasions of selected RSs (and corresponding beams) and associated FBs. That is, in S-BPB period #i, if sl-BP-RS #i_1 (which refers to sl-BP-RS transmitted on occasion #i_1) is selected, then the UE-B may transmit an sl-BP-FB on an occasion associated with occasion #i_1. Similarly, in S-BPB period #j, if sl-BP-RS #j_0 (which refers to sl-BP-RS transmitted on occasion #j_0) is selected, then the UE-B may transmit an sl-BP-FB on an occasion associated with occasion #j_0.

In the above embodiments, in the case that at least one sl-BP-FB is successfully received by the UE-A in the number (i.e., Num_{period}) of S-BPB periods as indicated in the sl-BP configuration, the sl-BP procedure is regarded as successful by the UE-A.

In the case that no sl-BP-FB is successfully received by the UE-A in the number (i.e., Num_{period}) of S-BPB periods as indicated by the sl-BP configuration, the sl-BP procedure is regarded as failed by the UE-A. In response to the sl-BP procedure being failed, the UE-A may trigger a new procedure for sidelink beam pairing. The new procedure may start from the procedure illustrated in FIG. 3 and include the procedures illustrated in FIGS. 3 and 4.

According to some embodiments of the present application, Case #1 may include a Case #1-2, which refers to a case where sl-BP-RS is carried by CSI-RS (which is transmitted based on method 1) and sl-BP-FB is carried by PSFCH. Thus, the type information included in the sl-BP configuration may indicate that the sl-BP-RS(s) is(are) carried by sidelink CSI-RS(s).

Specifically, a sidelink CSI-RS may be used for measuring channel state information (CSI) at an Rx UE receiving the CSI-RS. The CSI may be then fed back to a Tx UE transmitting the CSI-RS such that the Tx UE can adjust its transmission based on the fed back CSI.

In NR V2X, the transmission of SL CSI-RS may be supported for unicast transmissions only. An SL CSI-RS may be transmitted within the PSSCH region of a slot. In some embodiments of the present application, to request CSI feedback from an RX UE, a one-bit CSI request is sent in the 2^{nd} stage SCI with SCI format 2-A.

The design of the SL CSI-RS is based on the CSI-RS design of Rel-15 in NR Uu. In addition, the resource mapping of SL CSI-RS in a physical RB (PRB) is based on the CSI-RS resource mapping patterns in NR Uu, which support up to two antenna ports. Each PRB within PSSCH uses the same pattern for the SL CSI-RS.

The SL CSI-RS configuration includes the resource mapping pattern and the number of antenna ports for SL CSI-RS. The SL CSI-RS configuration may be selected by a Tx UE and provided to an Rx UE via PC5-radio resource control (RRC) configuration.

For case Case #1-2, the configuration information for sl-BP-RS and sl-BP-FB included in the sl-BP configuration may further include at least one of the following:
a number of CSI-RS windows;
a length of each CSI-RS window;
an offset of a first CSI-RS window relative to a reference point;
an association pattern between PSFCH occasion(s) and slot(s) of sidelink CSI-RS(s)

The aforementioned reference point may be a first slot (e.g., slot #0) of a first RF (e.g., RF #0).

Alternatively, the reference point may be a first slot (e.g., slot #0) of a first system frame (e.g., SFN #0).

Alternatively, the reference point may be a slot of a PUSCH transmission carrying the sl-BP-RQ message (e.g., from the UE-A to the BS as illustrated in FIG. 3). In some embodiments, the slot of the PUSCH transmission may be the first slot or the last slot of the PUSCH transmission. In this example, in order to enable the UE-B to determine the slot of the PUSCH transmission, the BS may indicate the slot of the PUSCH transmission carrying the sl-BP-RQ message to the UE-B.

Alternatively, the reference point may be a slot of a PDSCH transmission carrying the sl-BP-RQ message (e.g., from the BS to the UE-B as illustrated in FIG. 3). In some embodiments, the slot of the PDSCH transmission may be the first slot or the last slot of the PDSCH transmission. In this example, in order to enable the UE-A to determine the slot of the PDSCH transmission, in an embodiment, the UE-A may determine the slot of the PDSCH transmission to be a time offset (e.g., in units of slot) plus a slot of a PUSCH transmission carrying the sl-BP-RQ message (e.g., from the UE-A to the BS as illustrated in FIG. 3); in another embodiment, the BS may indicate the slot of the PDSCH transmission to the UE-A.

Alternatively, the reference point may be a slot in which the UE-A receives an ACK for a successful transmission of the sl-BP-RQ message from the BS to an intended UE (e.g., UE-B). In this example, in order to enable the UE-B to determine the slot in which the UE-A receives the ACK, the UE-B may determine the slot in which the UE-A receives the ACK to be a time offset (e.g., in units of slot) plus a slot in which the UE-B transmit an ACK to the BS to indicate the successful reception of the sl-BP-RQ message from the BS.

For example, the sl-BP configuration may include: a parameter Num_{window}, a parameter Offset, and a parameter Length_{window}. The parameter Num_{window} may indicate a number of CSI-RS windows for a beam pairing procedure. The parameter Offset may indicate an offset of a first CSI-RS window relative to a reference point as stated above, and may be represented in number of frame, slot or ms. The parameter Length_{window} may indicate a length of each CSI-RS window, and may be represented in number of ms or frame. Based on the above three parameters, a UE (e.g., UE-A or UE-B) may determine a configuration for CSI-RS windows (e.g., distribution of CSI-RS windows) for an sl-BP procedure.

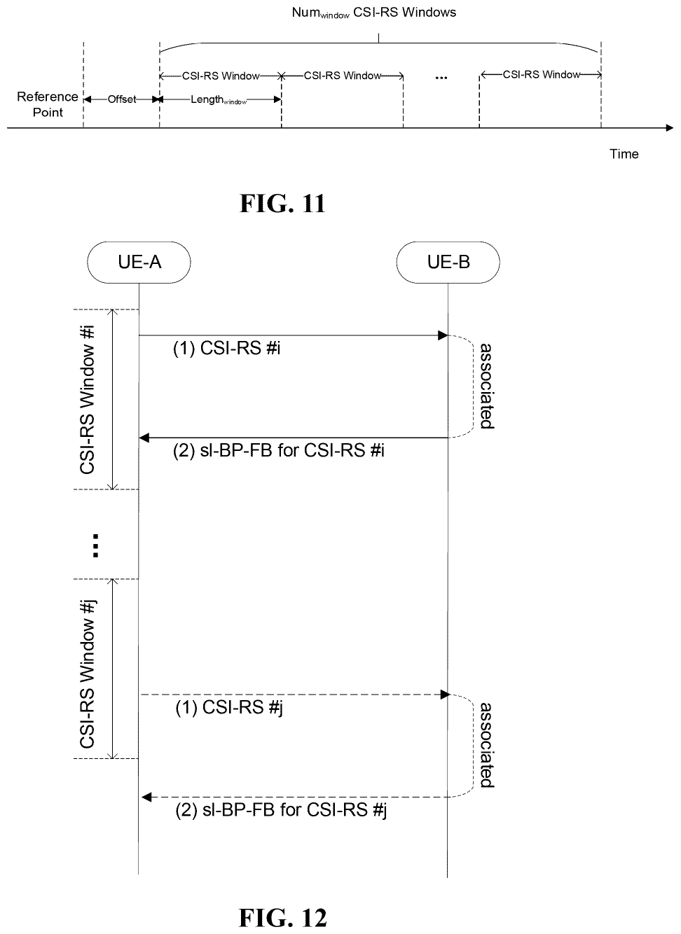

FIG. 11 illustrates an exemplary configuration for CSI-RS windows for an sl-BP procedure according to some embodiments of the present application. Specifically, in FIG. 11, the number of CSI-RS windows is Num_{window}. FIG. 11 also shows an offset (e.g., Offset) of a first CSI-RS window relative to a reference point and a length of each CSI-RS window (e.g., Length_{window}).

According to some embodiments of the present application, the association pattern included in the sl-BP configuration may indicate that each slot of CSI-RS is associated with a corresponding PSFCH occasion (e.g., PSFCH symbol).

Based on the sl-BP configuration described with respect to Case #1-2, the UE-A and the UE-B may perform corresponding operations as illustrated in FIG. 4. In Case #1-2, the sl-BP-RS(s) in FIG. 4 is(are) sidelink CSI-RS(s). The sidelink CSI-RS(s) transmitted based on the sl-BP configuration in Case #1-2 may be referred to as method 1 as mentioned above.

Specifically, in step 401, the UE-A may transmit at most one sidelink CSI-RS with beam(s) of the UE-A within each CSI-RS window based on the sl-BP configuration. Consequently, the UE-A may transmit a set of sidelink CSI-RSs within the number of CSI-RS windows with beams based on the sl-BP configuration. For example, each CSI-RS may be transmitted with a beam of the UE-A in a slot. The resource for transmitting each CSI-RS may be determined by the UE-A based on a sensing based resource selection or reselection procedure.

Consequently, in step 401, the UE-B may receive the set of CSI-RSs within the number of CSI-RS windows with beam(s) of the UE-B based on the sl-BP configuration.

After receiving the set of sidelink CSI-RSs, according to some embodiments of the present application, the UE-B may select one or more sidelink CSI-RSs within the set of CSI-RSs in step 402. For example, the one or more sidelink CSI-RSs may be CSI-RSs satisfying a condition (e.g., a measured CSI is larger than or equal to a CSI threshold). For example, the CSI may be any combination of channel quality indicator (CQI), rank indicator (RI), precoder-matrix indicator (PMI), and RSRP. In an embodiment of the present application, the UE-B may determine that beam(s) receiving the one or more CSI-RSs are the paired beam(s) for beam pairing with the UE-A.

After that, in step 403, the UE-B may transmit sl-BP-FB(s) for the one or more sidelink CSI-RSs on PSFCH occasion(s) (e.g., PSFCH symbols) associated with slot(s) of the one or more sidelink CSI-RSs. Specifically, for each sidelink CSI-RS of the one or more sidelink CSI-RSs, the UE-B may transmit an sl-BP-FB on an PSFCH occasion associated with a slot of the corresponding sidelink CSI-RS, wherein the PSFCH occasion associated with the slot of the corresponding sidelink CSI-RS may be determined based on the association pattern.

In some embodiments of the present application, each sl-BP-FB may include an indication of the corresponding sidelink CSI-RS, wherein the indication is one of the following: an ACK indicating that the corresponding sidelink CSI-RS is selected; or a slot indicator indicating the slot of the corresponding sidelink CSI-RS.

According to some other embodiments of the present application, in the case that none of the set of CSI-RSs satisfies the condition, the UE-B does not transmit any feedback on PSFCH occasion(s) to the UE-A.

The UE-A may attempt to receive sl-BP-FB(s) on the PSFCH occasion(s) for receiving sl-BP-FB(s) based on the sl-BP configuration.

In some embodiments of the present application, the UE-A may receive the sl-BP-FB(s) for the one or more sidelink CSI-RSs within the set of CSI-RSs in step 403. Then, the UE-A may identify beam(s) of the UE-A based on the received sl-BP-FB(s). The identified beam(s) may be the paired beam(s) for beam pairing with the UE-B.

For example, the UE-A may identify beam(s) based on an indication of a corresponding sidelink CSI-RS included in each sl-BP-FB. For example, based on the indication of the corresponding sidelink CSI-RS, the UE-A may determine a beam for transmitting the corresponding sidelink CSI-RS, and thus the UE-A may determine the beam as a paired beam for beam pairing with the UE-B.

FIG. 12 illustrates another exemplary timing diagram for sidelink beam pairing according to some embodiments of the present application.

In FIG. 12, two CSI-RS windows #i and #j in a plurality of CSI-RS windows for sidelink beam pairing procedure are illustrated.

In each CSI-RS window, the slot for transmitting CSI-RS is located dynamically within a corresponding CSI-RS window due to a sensing-based resource selection. Each slot for transmitting a CSI-RS is associated with a PSFCH occasion based on the association pattern. For example, each dashed arrow in FIG. 12 indicates a slot of selected CSI-RS (and corresponding beam) and an associated PSFCH occasion. That is, if CSI-RS #i in CSI-RS window #i is selected, then the UE-B may transmit sl-BP-FB for CSI-RS #i on a PSFCH occasion associated with a slot transmitting CSI-RS #i. Similarly, if CSI-RS #j in CSI-RS window #j is selected, then the UE-B may transmit an sl-BP-FB for CSI-RS #j on a PSFCH occasion (which is not within the CSI-RS window #j) associated with a slot transmitting CSI-RS #j. In the example shown in FIG. 12, CSI-RS #j is selected.

In the above embodiments, in the case that at least one sl-BP-FB on at least one PSFCH occasion is successfully received by the UE-A, the SL-BP procedure is regarded as successful by the UE-A.

In the case that no sl-BP-FB is successfully received by the UE-A on the PSFCH occasions associated with the sidelink CSI-RSs transmitted in the number of sidelink beam paring windows as indicated by the sl-BP configuration, the SL-BP procedure is regarded as failed by the UE-A. In response to the SL-BP procedure being failed, the UE-A may trigger a new procedure for sidelink beam pairing. The new procedure may start from the procedure illustrated in FIG. 3 and includes the procedures illustrated in FIGS. 3 and 4.

According to some embodiments of the present application, Case #1 may include a Case #1-3, which refers to a case where sl-BP-RS is carried by CSI-RS (which is transmitted based on method 2) and sl-BP-FB is carried by PSFCH. Thus, the type information included in the sl-BP configuration may also indicate that the sl-BP-RS(s) is(are) carried by sidelink CSI-RS(s). However, for Case #1-3, the configuration information for sl-BP-RS and sl-BP-FB included in the sl-BP configuration may be different from that for Case #1-2.

Specifically, for Case #1-3, the configuration information for sl-BP-RS and sl-BP-FB included in the sl-BP configuration may further include at least one of the following:
a length of a CSI-RS window;
an offset of the CSI-RS window relative to a reference point;
a maximum number of sidelink CSI-RSs in the CSI-RS window; or
an association pattern between PSFCH occasion(s) and slot(s) of sidelink CSI-RS(s).

The reference point described above with respect to Case #1-2 may also be applied to the reference point in Case #1-3.

For example, the sl-BP configuration may include: a parameter Num_{RS}, a parameter Offset, and a parameter Length_{window}. The parameter Num_{RS} may indicate a number of SL CSI-RSs which should be transmitted in the CSI-RS window. The parameter Offset may indicate an offset of the CSI-RS window relative to a reference point as stated above, and may be represented in number of frame, slot or ms. The parameter Length_{window} may indicate a length of the CSI-RS window, and may be represented in number of ms or frame. Based on the above three parameters, a UE (e.g., UE-A or UE-B) may determine a configuration for CSI-RS windows for an sl-BP procedure.

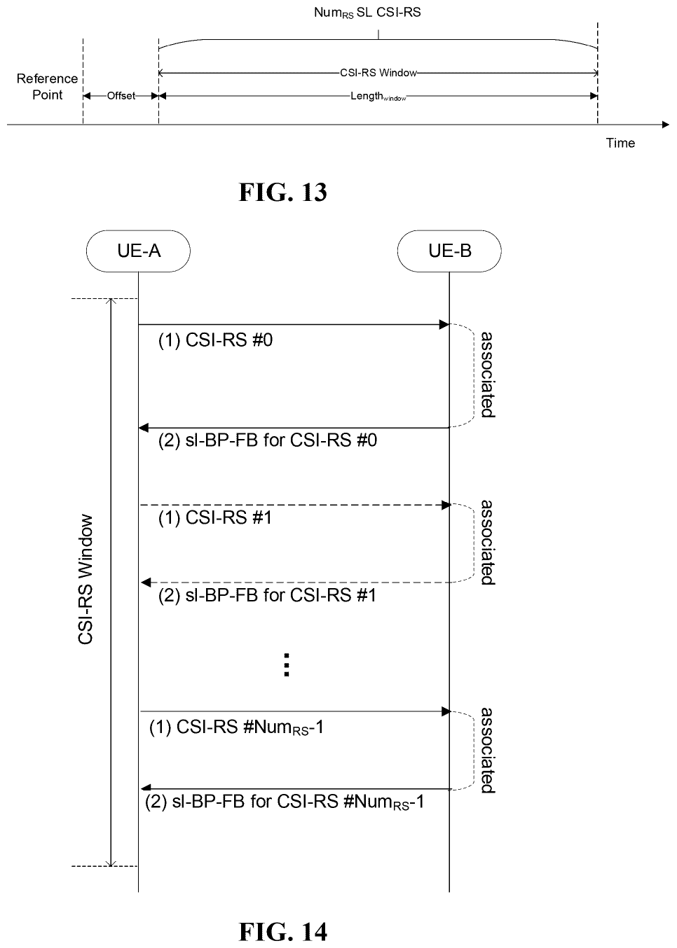

FIG. 13 illustrates an exemplary configuration for a CSI-RS window for an sl-BP procedure according to some embodiments of the present application. Specifically, in FIG. 13, the number of CSI-RSs in the CSI-RS window is Num_{RS}. FIG. 13 also shows an offset (e.g., Offset) of the CSI-RS window relative to a reference point and a length of the CSI-RS window (e.g., Length_{window}).

According to some embodiments of the present application, the association pattern included in the sl-BP configuration may indicate that each slot of CSI-RS is associated with a corresponding PSFCH occasion (e.g., PSFCH symbol).

Based on the sl-BP configuration described with respect to Case #1-3, the UE-A and the UE-B may perform corresponding operations as illustrated in FIG. 4. In Case #1-3, the sl-BP-RS(s) in FIG. 4 is(are) sidelink CSI-RS(s). The sidelink CSI-RS(s) transmitted based on the sl-BP configuration in Case #1-3 may be referred to as method 2 as mentioned above.

Specifically, in step 401, the UE-A may transmit a first number of sidelink CSI-RSs with beam(s) of the UE-A within the CSI-RS window based on the sl-BP configuration, wherein the first number is less than or equal to the maximum number of sidelink CSI-RSs indicated by the sl-BP configuration. Each sidelink CSI-RS of the first number of sidelink CSI-RSs may include an index of the sidelink CSI-RS which represents a transmission order of the sidelink CSI-RS within the first number of sidelink CSI-RSs (i.e., an index in a sequence of CSI-RS transmissions within the CSI-RS window), such that a UE (e.g., UE-B) receiving the sidelink CSI-RS can identify the transmission order of the sidelink CSI-RS. For example, each CSI-RS may be transmitted with a beam of the UE-A in a slot. The resource for transmitting each CSI-RS may be determined by the UE-A based on a sensing based resource selection or reselection procedure.

Consequently, in step 401, the UE-B may receive the first number of sidelink CSI-RSs within the CSI-RS window with beam(s) of the UE-B based on the sl-BP configuration.

After receiving the first number of CSI-RSs, according to some embodiments of the present application, the UE-B may select one or more sidelink CSI-RSs within the first number of CSI-RSs in step 402. For example, the one or more sidelink CSI-RSs may be CSI-RSs satisfying a condition (e.g., a measured CSI is larger than or equal to a CSI threshold). In an embodiment of the present application, the UE-B may determine that beam(s) receiving the one or more CSI-RSs are the paired beam(s) for beam pairing with the UE-A.

After that, in step 403, the UE-B may transmit sl-BP-FB(s) for the one or more sidelink CSI-RSs on PSFCH occasion(s) (e.g., PSFCH symbols) associated with slot(s) of the one or more sidelink CSI-RSs. Specifically, for each sidelink CSI-RS of the one or more sidelink CSI-RSs, the UE-B may transmit an sl-BP-FB on an PSFCH occasion associated with a slot of the corresponding sidelink CSI-RS, wherein the PSFCH occasion associated with the slot of the corresponding sidelink CSI-RS may be determined based on the association pattern.

In some embodiments of the present application, each sl-BP-FB may include an indication of the corresponding sidelink CSI-RS, wherein the indication is one of the following: an ACK indicating that the corresponding sidelink CSI-RS is selected; or a slot indicator indicating the slot of the corresponding sidelink CSI-RS.

According to some other embodiments of the present application, in the case that none of the set of CSI-RSs satisfies the condition, the UE-B does not transmit any feedback on PSFCH occasion(s) to the UE-A.

The UE-A may attempt to receive sl-BP-FB(s) on the PSFCH occasion(s) for receiving sl-BP-FB(s) based on the sl-BP configuration.

In some embodiments of the present application, the UE-A may receive the sl-BP-FB(s) for the one or more sidelink CSI-RSs within the number of CSI-RSs in step 403. Then, the UE-A may identify beam(s) of the UE-A based on the received sl-BP-FB(s). The identified beam(s) may be the paired beam(s) for beam pairing with the UE-B.

For example, the UE-A may identify beam(s) based on an indication of a corresponding sidelink CSI-RS included in each sl-BP-FB. For example, based on the indication of the corresponding sidelink CSI-RS, the UE-A may determine a beam for transmitting the corresponding sidelink CSI-RS, and thus the UE-A may determine the beam as a paired beam for beam pairing with the UE-B.

FIG. 14 illustrates another exemplary timing diagram for sidelink beam pairing according to some embodiments of the present application.

In FIG. 14, except for the first CSI-RS, each of the remaining CSI-RSs is transmitted after a PSFCH occasion associated with a slot of the immediately previous CSI-RS. The slots for transmitting CSI-RSs are located dynamically within the CSI-RS window due to a sensing-based resource selection. Each slot for transmitting a CSI-RS is associated with a PSFCH occasion based on the association pattern. For example, each dashed arrow in FIG. 14 indicates a slot of selected CSI-RS (and corresponding beam) and an associated PSFCH occasion. In the example shown in FIG. 14, a maximum of Num_{RS} sidelink CSI-RSs may be transmitted in the CSI-RS window, and CSI-RS #1 (which is transmitted with index #1 in a sequence of CSI-RS transmissions within the CSI-RS window, where such index #1 is also contained in CSI-RS #1) is selected, and the UE-B may transmit an sl-BP-FB for CSI-RS #1 on a PSFCH occasion associated with the slot transmitting CSI-RS #1.

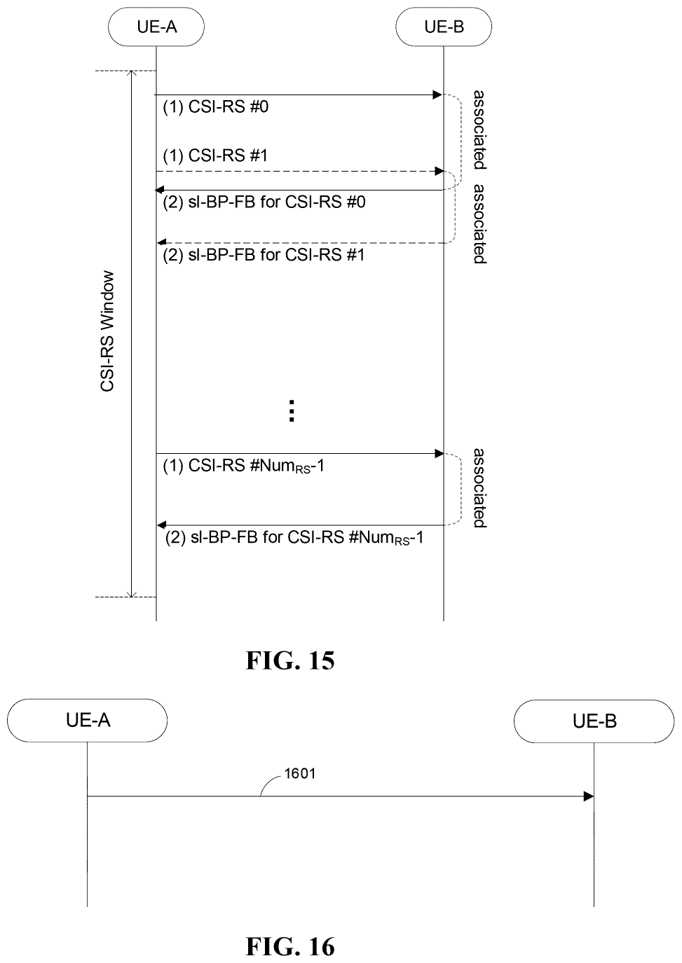

FIG. 15 illustrates another exemplary timing diagram for sidelink beam pairing according to some embodiments of the present application.

In FIG. 15, except the first CSI-RS, each of the remaining CSI-RSs is transmitted after the immediately previous CSI-RS. The slots for transmitting CSI-RSs are located dynamically within the CSI-RS window due to a sensing-based resource selection. Each slot for transmitting a CSI-RS is associated with a PSFCH occasion based on the association pattern. For example, each dashed arrow in FIG. 15 indicates a slot of selected CSI-RS (and corresponding beam) and an associated PSFCH occasion. In the example shown in FIG. 15, a maximum of Num_{RS} sidelink CSI-RSs may be transmitted in the CSI-RS window, and CSI-RS #1 (which is transmitted with index #1 in a sequence of CSI-RS transmissions within the CSI-RS window, where such index #1 is also contained in CSI-RS #1) is selected, and the UE-B may transmit an sl-BP-FB for CSI-RS #1 on a PSFCH occasion associated with the slot transmitting CSI-RS #1.

In the above embodiments, in the case that at least one sl-BP-FB on at least one PSFCH occasion is successfully received by the UE-A, the SL-BP procedure is regarded as successful by the UE-A.

In the case that no sl-BP-FB is successfully received by the UE-A on the PSFCH occasions associated with the first number of sidelink CSI-RSs, the SL-BP procedure is regarded as failed by the UE-A. In response to the SL-BP procedure being failed, the UE-A may trigger a new procedure for sidelink beam pairing. The new procedure may start from the procedure illustrated in FIG. 3 and includes the procedures illustrated in FIGS. 3 and 4.

The above embodiments illustrate the assistance information transmission procedure (i.e., stage 1) and sidelink beam pairing procedure (i.e., stage 2) for Case #1. Case #2 differs from Case #1 in stage 1. Specifically, in stage 1 of Case #2, the sl-BP-RQ message is transmitted from the UE-A to the UE-B over an existing connection between them in FR1 over sidelink.

FIG. 16 illustrates another exemplary assistance information transmission procedure (i.e., stage 1) according to some embodiments of the present application. The procedure in FIG. 16 may be applied to the aforementioned Case #2.

Referring to FIG. 16, in step 1601, UE-A may transmit SCI and a PSSCH transmission associated with the SCI to UE-B. The SCI (e.g., the 2^{nd} stage SCI) may include information (e.g., in form of one-bit) for triggering an sl-BP procedure. The PSSCH transmission may include a TB carrying an sl-BP-RQ message. The contents included in the sl-BP-RQ message may be the same as those included in the sl-BP-RQ message as described above with respect to FIG. 3.

The stage 2 (i.e., the sidelink beam pairing procedure) for Case #1 and Case #2 are the same. That is, the sidelink beam pairing procedure illustrated in FIG. 4 is also applied for Case #2.

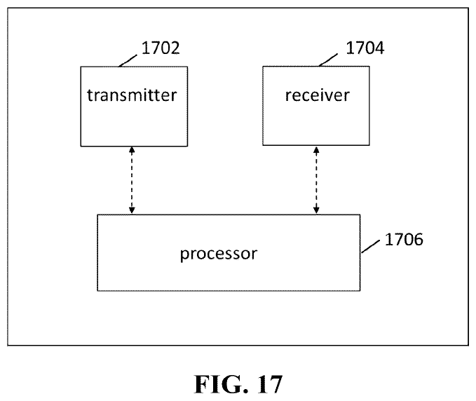

FIG. 17 illustrates a simplified block diagram of an exemplary apparatus for beam pairing according to some embodiments of the present application. In some embodiments, the apparatus 1700 may be or include at least part of a UE (e.g., UE 101a or UE 101b in FIG. 1, or UE-A or UE-B in FIGS. 2-4, 10, 12, and 14-16). In some other embodiments, the apparatus 1700 may be or include at least part of a BS (e.g., BS 102 in FIG. 1 or BS in FIG. 3).

Referring to FIG. 17, the apparatus 1700 may include at least one transmitter 1702, at least one receiver 1704, and at least one processor 1706. The at least one transmitter 1702 is coupled to the at least one processor 1706, and the at least one receiver 1704 is coupled to the at least one processor 1706.

Although in this figure, elements such as the transmitter 1702, the receiver 1704, and the processor 1706 are illustrated in the singular, the plural is contemplated unless a limitation to the singular is explicitly stated. In some embodiments of the present application, the transmitter 1702 and the receiver 1704 may be combined to one device, such as a transceiver. In some embodiments of the present application, the apparatus 1700 may further include an input device, a memory, and/or other components. The transmitter 1702, the receiver 1704, and the processor 1706 may be configured to perform any of the methods described herein (e.g., the method described with respect to any of FIGS. 2-4, 10, 12, and 14-16).

According to some embodiments of the present application, the apparatus 1700 may be a UE transmitting sl-BP-RS(s) and receiving sl-BP-FB(s) (e.g., UE-A in FIGS. 2-4, 10, 12, and 14-16), and the transmitter 1702, the receiver 1704, and the processor 1706 may be configured to perform operations of the any method as described with respect to FIGS. 2-4, 10, 12, and 14-16. For example, the transmitter 1702 may be configured to: transmit an sl-BP-RQ message, wherein the sl-BP-RQ message includes an sl-BP configuration; and transmit sl-BP-RS(s) based on the sl-BP configuration. The receiver may be configured to receive sl-BP-FB(s) for one or more sl-BP-RSs within the sl-BP-RS(s) based on the sl-BP configuration.

According to some embodiments of the present application, the apparatus 1700 may be a UE transmitting sl-BP-FB(s) and receiving sl-BP-RS(s) (e.g., UE-B in FIGS. 2-4, 10, 12, and 14-16), and the transmitter 1702, the receiver 1704, and the processor 1706 may be configured to perform operations of any method as described with respect to FIGS. 2-4, 10, 12, and 14-16. For example, the receiver 1704 may be configured to: receive an sl-BP-RQ message, wherein the sl-BP-RQ message includes an sl-BP configuration; and receive sl-BP-RS(s) based on the sl-BP configuration. The processor 1706 may be configured to select one or more sl-BP-RSs within the sl-BP-RS(s). The transmitter 1702 may be configured to transmit sl-BP-FB(s) for the one or more sl-BP-RSs based on the sl-BP configuration.

According to some embodiments of the present application, the apparatus 1700 may be a BS, and the transmitter 1702, the receiver 1704, and the processor 1706 may be configured to perform operations of the method as described with respect to FIG. 3. For example, the receiver 1704 may be configured to receive an sl-BP-RQ message from a UE, wherein the sl-BP-RQ message includes an sl-BP configuration which indicates at least one intended UE of the sl-BP-RQ message. The transmitter 1702 may be configured to transmit the sl-BP-RQ message to each of the at least one intended UE.

In some embodiments of the present application, the apparatus 1700 may further include at least one non-transitory computer-readable medium. In some embodiments of the present disclosure, the non-transitory computer-readable medium may have stored thereon computer-executable instructions to cause the processor 1706 to implement any of the methods as described above. For example, the computer-executable instructions, when executed, may cause the processor 1706 to interact with the transmitter 1702 and/or the receiver 1704, so as to perform operations of the methods, e.g., as described with respect to FIGS. 2-4, 10, 12, and 14-16.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for sidelink beam management, including a processor and a memory. Computer programmable instructions for implementing a method for sidelink beam management are stored in the memory, and the processor is configured to perform the computer programmable instructions to implement the method for sidelink beam management. The method for sidelink beam management may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for sidelink beam management according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
transmit a sidelink beam pairing request (sl-BP-RQ) message, wherein the sl-BP-RQ message comprises a sidelink beam pairing (sl-BP) configuration;
transmit one or more sidelink beam pairing reference signals (sl-BP-RSs) based on the sl-BP configuration; and
receive one or more sidelink beam pairing feedbacks (sl-BP-FBs) for one or more sl-BP-RSs within the sl-BP-RSs based on the sl-BP configuration.

2. The UE of claim 1, wherein the at least one processor is further configured to cause the UE to transmit a sidelink beam pairing scheduling request (sl-BP-SR) in a physical uplink control channel (PUCCH) to a base station (BS), wherein the sl-BP-SR includes at least one of:
information for triggering an sl-BP procedure; or
information for requiring physical uplink shared channel (PUSCH) resources for transmitting the sl-BP-RQ message.

3. The UE of claim 2, wherein the sl-BP-SR is transmitted on a PUCCH resource dedicated for sl-BP.

4. The UE of claim 1, wherein the at least one processor is further configured to cause the UE to transmit information for triggering an sl-BP procedure in sidelink control information (SCI) associated with a transport block (TB) carrying the sl-BP-RQ message.

5. The UE of claim 1, wherein the sl-BP configuration includes at least one of the following:
type information indicating whether the UE is a UE for transmitting sl-BP-RS or a UE for transmitting sl-BP-FB;
an identification (ID) of the UE;
a parameter used for scrambling the one or more sl-BP-RSs;
a priority of an intended traffic from the UE;
type information of the intended traffic from the UE;
a target UE list including at least one intended UE of the sl-BP-RQ message; or
a zone ID.

6. The UE of claim 1, wherein the sl-BP configuration includes type information indicating whether the sl-BP-RSs are carried by sidelink beam paring blocks (S-BPBs) or sidelink channel state information reference signals (CSI-RSs).

7. The UE of claim 6, wherein the type information indicates that the sl-BP-RSs are carried by S-BPBs, and the sl-BP configuration further includes at least one of the following:
a number of S-BPB periods;
an offset of a first S-BPB period relative to a reference point, wherein the reference point is a first slot of a first radio frame (RF) or a first slot of a first system frame;
a length of each S-BPB period;
an S-BPB offset within each S-BPB period;
an S-BPB interval within each S-BPB period;
a number of S-BPB occasions within each S-BPB period; or
an association pattern between occasions for sl-BP-RS and occasions for sl-BP-FB.

8. The UE of claim 7,
wherein, in order to transmit the one or more sl-BP-RSs, the at least one processor is configured to cause the UE to transmit the one or more sl-BP-RSs on occasions for sl-BP-RS in each S-BPB period with beams based on the sl-BP configuration; and
wherein, in order to receive the sl-BP-FBs, the at least one processor is configured to cause the UE to receive the one or more sl-BP-FBs on occasions for sl-BP-FB associated with one or more occasions for the one or more sl-BP-RSs, wherein each sl-BP-FB includes an sl-BP-RS occasion indicator indicating an occasion for an sl-BP-RS of the one or more sl-BP-RSs.

9. The UE of claim 6, wherein the type information indicates that the one or more sl-BP-RSs are carried by sidelink CSI-RSs, and the sl-BP configuration further includes at least one of the following:
a number of CSI-RS windows;
a length of each CSI-RS window;
an offset of a first CSI-RS window relative to a reference point, wherein the reference point is one of:
a first slot of a first radio frame (RF);
a first slot of a first system frame;
a slot of a physical uplink shared channel (PUSCH) transmission carrying the sl-BP-RQ message;
a slot of a physical downlink shared channel (PDSCH) transmission carrying the sl-BP-RQ message from a BS to an intended UE; or
a slot in which the UE receives an acknowledgement (ACK) for a successful transmission of the sl-BP-RQ message from a BS to an intended UE; or
an association pattern between physical sidelink feedback channel (PSFCH) occasions and slots-slot(s) of sidelink CSI-RSs.

10. The UE of claim 9,
wherein, in order to transmit the one or more sl-BP-RSs, the at least one processor is configured to cause the UE to transmit a set of sidelink CSI-RSs as the sl-BP-RSs within the number of CSI-RS windows with beams based on the sl-BP configuration, wherein at most one sidelink CSI-RS is transmitted within each CSI-RS window; and
wherein, in order to receive the one or more sl-BP-FBs, the at least one processor is configured to cause the UE to receive each sl-BP-FB of the sl-BP-FBs on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following:
an acknowledgement (ACK) indicating that the corresponding sidelink CSI-RS is selected; or
a slot indicator indicating the slot of the corresponding sidelink CSI-RS.

11. The UE of claim 6, wherein the type information indicates that the sl-BP-RSs are carried by sidelink CSI-RSs, and the sl-BP configuration further includes at least one of the following:
a length of a CSI-RS window;
an offset of the CSI-RS window relative to a reference point, wherein the reference point is one of:
a first slot of a first radio frame (RF);
a first slot of a first system frame;
a slot of a physical uplink shared channel (PUSCH) transmission carrying the sl-BP-RQ message;
a slot of a physical downlink shared channel (PDSCH) transmission carrying the sl-BP-RQ message from a BS to an intended UE; or
a slot in which the UE receives an acknowledgement (ACK) for a successful transmission of the sl-BP-RQ message from a BS to an intended UE;
a maximum number of sidelink CSI-RSs in the CSI-RS window; or
an association pattern between physical sidelink feedback channel (PSFCH) occasions and slots of sidelink CSI-RSs.

12. The UE of claim 11,
wherein, in order to transmit the sl-BP-RSs, the at least one processor is configured to cause the UE to transmit a first number of sidelink CSI-RSs as the sl-BP-RSs within the CSI-RS window with beams based on the sl-BP configuration, wherein the first number is less than or equal to the maximum number; and
wherein in order to receive the sl-BP-FBs, the at least one processor is configured to cause the UE to receive each sl-BP-FB of the sl-BP-FBs on a PSFCH occasion associated with a slot of a corresponding sidelink CSI-RS of one or more sidelink CSI-RSs as the one or more sl-BP-RSs, wherein each sl-BP-FB includes an indication of the corresponding sidelink CSI-RS, wherein the indication is one of the following:
an acknowledgement (ACK) indicating that the corresponding sidelink CSI-RS is selected; or
a slot indicator indicating the slot of the corresponding sidelink CSI-RS.

13. The UE of claim 12, wherein each sidelink CSI-RS of the first number of sidelink CSI-RSs includes an index of the sidelink CSI-RS.

14. A user equipment (UE) for wireless communication, comprising:
at least one memory; and
at least one processor coupled with the at least one memory and configured to cause the UE to:
receive a sidelink beam pairing request (sl-BP-RQ) message, wherein the sl-BP-RQ message comprises a sidelink beam pairing (sl-BP) configuration;
receive one or more sidelink beam pairing reference signals (sl-BP-RSs based on the sl-BP configuration;
select one or more sl-BP-RSs within the sl-BP-RSs; and
transmit one or more sidelink beam pairing feedbacks (sl-BP-FBs) for the one or more sl-BP-RSs based on the sl-BP configuration.

15. A base station (BS) for wireless communication, comprising:
at least one memory; and
at least one processor coupled with the at least one memory and configured to cause the BS to:
receive a sidelink beam pairing request (sl-BP-RQ) message from a user equipment (UE), wherein the sl-BP-RQ message comprises a sidelink beam pairing (sl-BP) configuration which indicates at least one intended UE of the sl-BP-RQ message; and
transmit the sl-BP-RQ message to each of the at least one intended UE.

16. A processor for wireless communication, comprising:
at least one controller coupled with at least one memory and configured to cause the processor to:
transmit a sidelink beam pairing request (sl-BP-RQ) message, wherein the sl-BP-RQ message comprises a sidelink beam pairing (sl-BP) configuration;
transmit one or more sidelink beam pairing reference signals (sl-BP-RSs) based on the sl-BP configuration; and
receive one or more sidelink beam pairing feedbacks (sl-BP-FBs) for one or more sl-BP-RSs within the sl-BP-RSs based on the sl-BP configuration.

17. The processor of claim 16, wherein the at least one controller is further configured to cause the processor to transmit a sidelink beam pairing scheduling request (sl-BP-SR) in a physical uplink control channel (PUCCH) to a base station (BS), wherein the sl-BP-SR includes at least one of:
information for triggering an sl-BP procedure; or
information for requiring physical uplink shared channel (PUSCH) resources for transmitting the sl-BP-RQ message.

18. The processor of claim 17, wherein the sl-BP-SR is transmitted on a PUCCH resource dedicated for sl-BP.

19. The processor of claim 16, wherein the at least one controller is further configured to cause the processor to transmit information for triggering an sl-BP procedure in sidelink control information (SCI) associated with a transport block (TB) carrying the sl-BP-RQ message.

20. The processor of claim 16, wherein the sl-BP configuration includes at least one of the following:
type information indicating whether the processor is a user equipment (UE) for transmitting sl-BP-RS or a UE for transmitting sl-BP-FB;
an identification (ID) of the processor;
a parameter used for scrambling the one or more sl-BP-RSs;
a priority of an intended traffic from the processor;
type information of the intended traffic from the processor;
a target UE list including at least one intended UE of the sl-BP-RQ message; or
a zone ID.
